(19) United States
(12) Patent Application Publication
(10) Pub. No.: US 2026/0339236 A1
(43) Pub. Date: Oct. 29, 2026

(54) DEVELOPING DEVICE WITH DEVELOPER-REFRESH-MODE

(71) Applicant: Hewlett-Packard Development Company, L.P., Spring, TX (US)

(72) Inventors: Naoya Iwata, Yokohama (JP); Koichi Utsunomiya, Yokohama (JP); Kazuhiko Takemoto, Yokohama (JP)

(73) Assignee: Hewlett-Packard Development Company, L.P., Spring, TX (US)

(21) Appl. No.: 19/119,744

(22) PCT Filed: Jan. 6, 2023
(86) PCT No.: PCT/US2023/010359

§ 371 Date: Apr. 9, 2025

(30) Foreign Application Priority Data
Oct. 27, 2022 (JP) 2022-172377

(51) Int. Cl. G03G 15/08; G03G 15/00

(52) U.S. Cl. CPC G03G 15/0891; G03G 15/0808; G03G 15/0865; G03G 15/5062; G03G 15/556

(57) ABSTRACT

An image forming apparatus includes a photoreceptor, the photoreceptor including a surface on which a toner image is formed; a developing device including an auger to supply a developer, the developer including a toner and a carrier; and a control unit to control execution of a carrier refresh mode by driving the auger when a remaining amount of the toner in the developing device becomes smaller than a threshold value.

### CROSS-REFERENCE TO RELATED PATENT APPLICATIONS

This application claims priority to Japanese Patent Application No. 2022-172377, filed on Oct. 27, 2022, the entirety of which is incorporated by reference herein.

### BACKGROUND

An image forming apparatus includes a developing device which mixes a developer containing a toner and a carrier, and the image forming apparatus includes a photoreceptor which forms a toner image from the toner in the developer. The developing device includes an auger which mixes the developer, and the developing device includes a developing roller which holds the mixed developer. The image forming apparatus further includes a cleaner which removes an excess toner remaining on a surface of the photoreceptor.

### BRIEF DESCRIPTION OF THE DRAWINGS

FIG. 1 is a schematic view of an image forming apparatus to perform various examples.

FIG. 2 is a cross-sectional view of a cleaner in an image forming apparatus.

FIG. 3 is a cross-sectional view of a toner return path in an image forming apparatus.

FIG. 4 is a flowchart of an example method for implementing the carrier refresh mode.

FIG. 5 is an example graph showing a relationship between a voltage value and a ratio of a toner with respect to a carrier.

### DETAILED DESCRIPTION

Hereinafter, various examples of an image forming apparatus are described with reference to the drawings. In the description with respect to the drawings, the same reference numerals are given to the same or corresponding elements, and overlapping descriptions may be omitted. The drawings may be partially simplified or exaggerated for ease of understanding, and dimensional ratios and the like are not limited to those described in the drawings.

An image forming apparatus according to the present disclosure includes a developing device to store a two-component developer, which contains a toner and a carrier. The image forming apparatus includes a photoreceptor, and the photoreceptor includes a surface on which a toner image is formed. The image forming apparatus includes a toner return path via which a toner is transferred from the photoreceptor to the developing device. The developing device includes an auger which conveys a developer, and a developing roller which holds the developer conveyed by the auger. For example, the image forming apparatus may include a cleaner which collects a toner remaining on a surface of the photoreceptor. The toner collected by the cleaner is returned to the developing device through the toner return path.

For example, the image forming apparatus may include a control unit which controls the execution of a carrier refresh mode and a toner consumption mode. In the toner consumption mode, for example, a conveying speed of the toner in the cleaner may be decreased, and the developing device prints an image on the photoreceptor by rotating the developing roller at a speed equal to or larger than the speed during printing while applying the same bias. Accordingly, since the toner is discharged from the developing device, and the return of the toner from the cleaner to the developing device is delayed, the mixing ratio of the toner to the carrier (hereinafter, sometimes referred to as the toner-carrier mixing ratio) inside the developing device decreases.

As a method of extending the lifespan of the developing device, an example method of extending the lifespan of the developer is described. The life of the developer is indicated by the developer charging ability. However, an external additive of the toner may adhere to the carrier of the developer, and when the external additive adheres to the surface of the carrier, the developer charging ability may decrease. The external additive may be, for example, silica (Si) added to the toner. When silica adheres to the surface of the carrier, the charging performance of the carrier decreases according to the amount of adhered silica.

In the above-described carrier refresh mode, the external additive on the surface of the carrier can be scraped off by rotating the developing roller while the toner-carrier mixing ratio inside the developing device decreases. Since the charging performance of the carrier can be recovered by scraping off the external additive from the carrier, the lifespan of the developer and the developing device can be extended. More specifically, when the toner-carrier mixing ratio inside the developing device decreases, the surface of the carrier may be exposed.

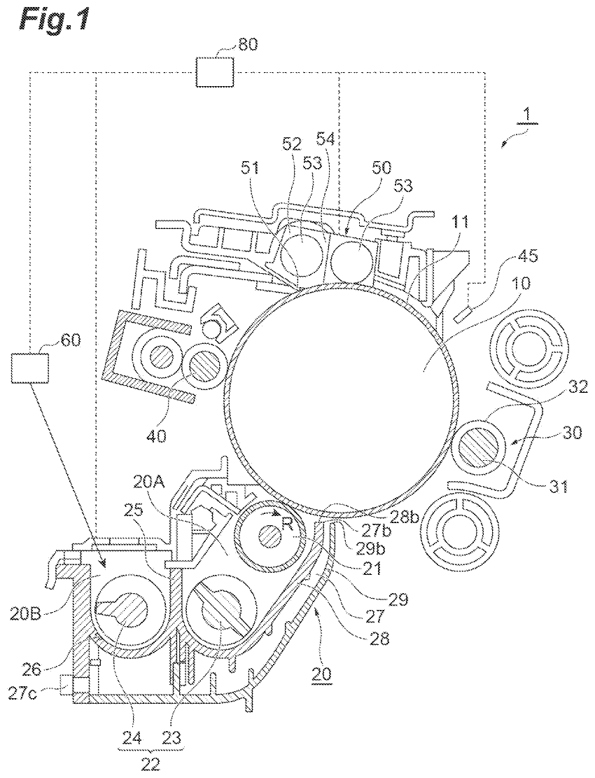

FIG. 1 is a schematic view of an image forming apparatus to perform various examples. The image forming apparatus 1 includes a photoreceptor 10, a developing device 20, and a transfer device 30. The photoreceptor 10 is an electrostatic latent image carrier. For example, the photoreceptor 10 may be a photoreceptor drum. The photoreceptor 10 forms an electrostatic latent image to form a toner image. For example, the image forming apparatus 1 may include a charging device 40 and a cleaner 50. The charging device 40 and the cleaner 50 are arranged at positions to face a surface 11 of the photoreceptor 10. The charging device 40 charges the surface 11 of the photoreceptor 10 to a predetermined potential.

In the developing device 20, a developer may be a two-component developer containing a toner and a carrier. In the developing device 20, the toner and the carrier are adjusted to a desired mixing ratio. When the toner and the carrier are mixed and agitated, the toner is uniformly dispersed, and the developer is prepared with an optimal charge amount.

For example, the image forming apparatus 1 may include a toner cartridge 60 to supply a toner to the developing device 20. The developing device 20 receives the toner supplied from the toner cartridge 60 and forms a toner image on the surface 11 of the photoreceptor 10. The developing device 20 includes a developing roller 21 to supply a toner to the surface 11 of the photoreceptor 10 so that an electrostatic latent image formed on the surface 11 of the photoreceptor 10 is developed. Accordingly, a toner image corresponding to the electrostatic latent image, that is, the toner image corresponding to an image to be formed on a print medium (e.g., a paper) is formed on the surface 11 of the photoreceptor 10.

For example, the developing device 20 may have a storage area 20A to store a developer, and a conveying area 20B to convey a developer to the storage area 20A. The storage area 20A is provided at a position closer to the photoreceptor 10 than the conveying area 20B. The developing device 20 includes an auger 22 to supply a developer to the developing roller 21. The auger 22 supplies a developer containing a toner and a carrier to the developing roller 21.

The auger 22 may be to agitate and convey the developer. For example, the developing device 20 may include a plurality of augers 22, and the plurality of augers 22 may include a supply auger 23 and an admix auger 24. The supply auger 23 is to supply a developer to the developing roller 21. The admix auger 24 extends in parallel to the supply auger 23 and is disposed on the side opposite to the developing roller 21 when viewed from the supply auger 23.

The developing roller 21 and the supply auger 23 are stored in the storage area 20A of the developing device 20. The admix auger 24 is stored in the conveying area 20B of the developing device 20. The developing device 20 includes a wall portion 25, which partitions the storage area 20A and the conveying area 20B. The developing device 20 includes an opening, which is located at the end portion of the wall portion 25 in the axial direction of the supply auger 23 (a direction orthogonal to the paper surface of FIG. 1). The developer of the conveying area 20B moves to the storage area 20A through the opening. In case the developer conveyed by the admix auger 24 accumulates in the above described opening, high airtightness may be applied between the storage area 20A and the conveying area 20B.

In the storage area 20A, the supply auger 23 is to agitate the developer, and the developing roller 21 is to hold the developer. The developing device 20 may include, for example, a TC sensor 26. The TC sensor 26 may be disposed at a position facing the admix auger 24. The TC sensor 26 detects the density of the developer stored in the developing device 20. For example, the TC sensor 26 may be a magnetic permeability sensor that detects the toner-carrier mixing ratio based on the magnetic permeability of the developer.

The developing device 20 includes an external additive containing portion 27 to store an external additive scraped off from the carrier. The external additive scatters from the developing roller 21 due to a centrifugal force generated by the rotation of the developing roller 21. The external additive containing portion 27 may be provided on, for example, the downstream side of the rotation direction R of the developing roller 21. More specifically, the developing device 20 includes a first wall portion 28 and a second wall portion 29, wherein the first wall portion 28 and the second wall portion 29 are arranged on the downstream side of the rotation direction R of the developing roller 21, and the external additive containing portion 27 is provided between the first wall portion 28 and the second wall portion 29. The first wall portion 28 includes a first end portion 28b facing the photoreceptor 10, and the second wall portion 29 includes a second end portion 29b facing the photoreceptor 10.

The external additive containing portion 27 includes an opening 27b, which is defined by the first end portion 28b and the second end portion 29b, and receives the external additive from the opening 27b. A suction device 27c, connected to the developing device 20, sucks the external additive to the external additive containing portion 27. The suction device 27c may be installed on, for example, an outer wall surface of the developing device 20. For example, a filter may be provided on the outer wall surface of the developing device 20, and the suction device 27c may be disposed on the outside of the filter. The suction device 27c may be, for example, a fan. In this case, when the suction device 27c rotates, the external additive floating from the developing roller 21 enters the external additive containing portion 27 from the opening 27b, and this external additive is stored in the external additive containing portion 27.

The transfer device 30 transfers a toner image developed on the photoreceptor 10 by the developing device 20 to a print medium. For example, the transfer device 30 may include a transfer roller 31. The transfer roller 31 may have, for example, an axis extending in parallel to the axis of the photoreceptor 10. A surface 32 of the transfer roller 31 and the surface 11 of the photoreceptor 10 are in contact with each other, and a transfer region is formed between the transfer roller 31 and the photoreceptor 10. The transfer roller 31 applies an electric field to the print medium conveyed to the transfer region so that the toner image formed on the surface 11 of the photoreceptor 10 is transferred to the print medium. The toner image is transferred to the print medium conveyed to the transfer region by the transfer roller 31. Further, the image forming apparatus 1 includes an optical sensor 45 disposed between the transfer device 30 and the cleaner 50. The optical sensor 45 is to measure the density of the toner in a patch, as described in detail later.

The cleaner 50 removes a toner remaining on the surface 11 of the photoreceptor 10. The cleaner 50 collects the toner remaining on the surface 11 of the photoreceptor 10, the toner not transferred to the print medium. The cleaner 50 is used as a temporary storage space for the collected toner. The cleaner 50 includes a blade 51. The cleaner 50 removes the toner from the photoreceptor 10 and collects the toner such that the blade 51 scrapes off the toner remaining on the surface 11 of the photoreceptor 10. The blade 51 is fixed to a housing of the image forming apparatus 1, and the blade 51 is to contact the surface 11 of the photoreceptor 10.

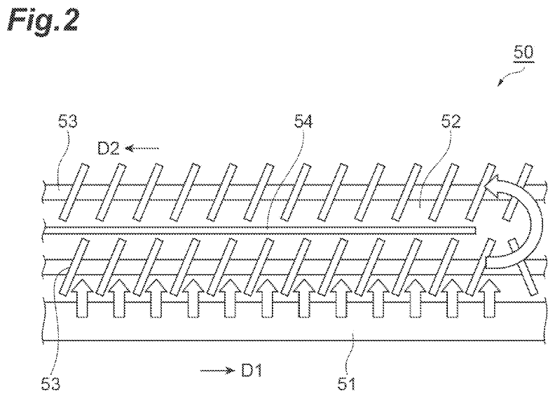

FIG. 2 is a cross-sectional view of a cleaner in an image forming apparatus, specifically a schematic view of an internal structure of the cleaner 50. As shown in FIGS. 1 and 2, the cleaner 50 includes a toner conveying path 52, which has a cylindrical shape. A conveying member 53 conveys a toner inside the toner conveying path 52. For example, the cleaner 50 may include two conveying members 53 that extend in a conveying direction extending along the toner conveying path 52, and a partition wall 54 may be located between two conveying members 53. One of two conveying members 53 (e.g., a first conveying member) conveys the toner to the end portion in the conveying direction D1. The other of the two conveying members 53 (e.g., a second conveying member) conveys the toner (conveyed to the end portion in the conveying direction D1) to the end portion in a direction D2, wherein the direction D2 may be, for example, opposite to the conveying direction D1.

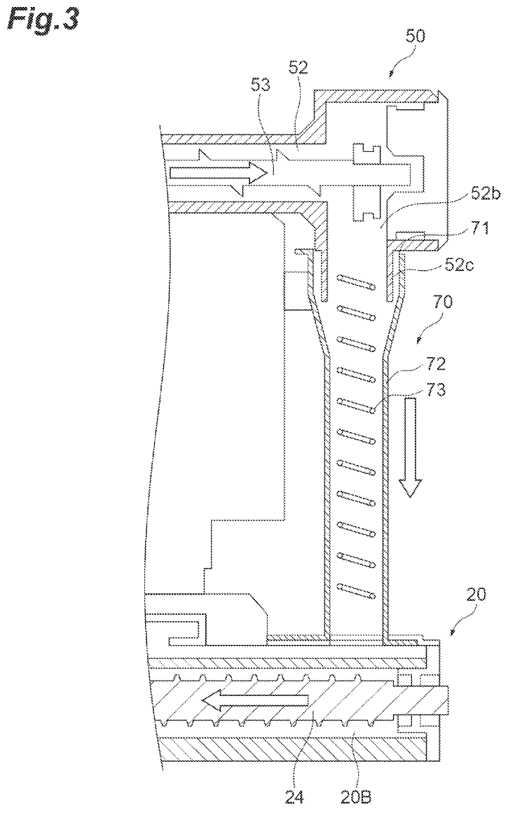

FIG. 3 is a cross-sectional view of a toner return path 70 in an image forming apparatus. The cleaner 50 includes the toner return path 70 via which a toner is transferred from the photoreceptor 10 to the auger 22 of the developing device 20. As shown in FIG. 3, the toner return path 70 connects the toner conveying path 52 and the conveying area 20B of the developing device 20. For example, the toner return path 70 may extend from the toner conveying path 52 to the outside of the cleaner 50. The toner return path 70 includes an entrance 71 formed at an end portion 52b of the toner conveying path 52. For example, the toner conveying path 52 may include a cylindrical portion 52c. The cylindrical portion 52c may protrude toward the developing device 20 such that the cylindrical portion 52c is fitted into the toner return path 70.

The toner return path 70 may include, for example, a cylindrical portion 72 extending from the toner conveying path 52 to the developing device 20. The toner return path 70 may include a toner crushing member 73 disposed inside the cylindrical portion 72, and the toner crushing member may include a spring portion to crush the toner passing through inside the cylindrical portion 72. The cylindrical portion 72 has a cylindrical body, which defines a path where a toner is supplied from the cleaner 50 to the developing device 20. The toner crushing member 73 may be a coil spring wherein a coil may be formed in a spiral shape, for example.

As shown in FIG. 1, the image forming apparatus 1 includes a control unit 80, which controls the developing device 20 and the cleaner 50. The control unit 80 may execute, for example, a carrier refresh mode and a toner consumption mode. The control unit 80 controls the execution of the carrier refresh mode by driving the auger 22 when the toner is consumed and a remaining amount of toner in the developing device 20 is smaller than a threshold value. The remaining amount of toner may indicate, for example, the remaining amount of toner inside the developing device 20 or the toner-carrier mixing ratio inside the developing device 20. As one example method of calculating the remaining amount of toner in the developing device 20, the density of the toner may be determined as described later. However, calculating the remaining amount of toner in the developing device 20 is not limited to the method based on measuring the density of the toner.

For example, the control unit 80 may include a dot counter to count the number of dots according to input image information (information on printed matter). The control unit 80 executes the carrier refresh mode when the number of dots counted from the image of the print medium or the density of the toner of the developing device 20 exceeds a threshold value. The control unit 80 may execute the carrier refresh mode when the number of dots counted from the image exceeds a threshold value. The control unit 80 may execute the carrier refresh mode when the density of the toner of the developing device 20 exceeds a threshold value. Further, the control unit 80 may execute the carrier refresh mode when the number of dots counted from the image of the print medium exceeds a threshold value and the density of the toner of the developing device 20 exceeds a threshold value. In this case, execution conditions for the carrier refresh mode may be set with higher accuracy. Further, the control unit 80 may execute the carrier refresh mode and the toner consumption mode when the operation time of the toner cartridge 60 exceeds a predetermined value for cartridge operation time.

The carrier refresh mode is a mode to remove the external additive from the carrier by rotating the developing roller 21 when, for example, the toner-carrier mixing ratio inside the developing device 20 is low. The control unit 80 may stop the toner from being transferred from the toner conveying path 52 to the developing device 20 in the carrier refresh mode. The carrier refresh mode may be executed, for example, when an image is not formed on the print medium. In the carrier refresh mode, the surface of the carrier is scraped by rotating the developing roller 21 when, for example, the toner-carrier mixing ratio of the developer inside the developing device 20 decreases.

The toner consumption mode is a mode to decrease the toner-carrier mixing ratio of the developing device 20 by transferring the toner of the developing device 20 to the photoreceptor 10. The control unit 80 controls the rotation of the conveying member 53 so that the rotation speed of the conveying member 53 in the toner consumption mode becomes slower than the rotation speed of the conveying member 53 that is not in the toner consumption mode. By executing the toner consumption mode, the control unit 80 decreases the toner-carrier mixing ratio of the developing device 20 by transferring the toner of the developing device 20 to the photoreceptor 10. Further, the control unit 80 executes the carrier refresh mode when the toner consumption mode is executed. Accordingly, in the carrier refresh mode, the surface of the carrier is scraped by the rotation of the developing roller 21, and the external additive is removed from the carrier. For example, the control unit 80 may execute the carrier refresh mode and the toner consumption mode when there is no print job for forming an image on the print medium. The control unit 80 outputs an alert when the number of times of executing the carrier refresh mode is equal to or larger than a predetermined number of times. The alert may be, for example, an alert that prompts replacement of the developing device 20.

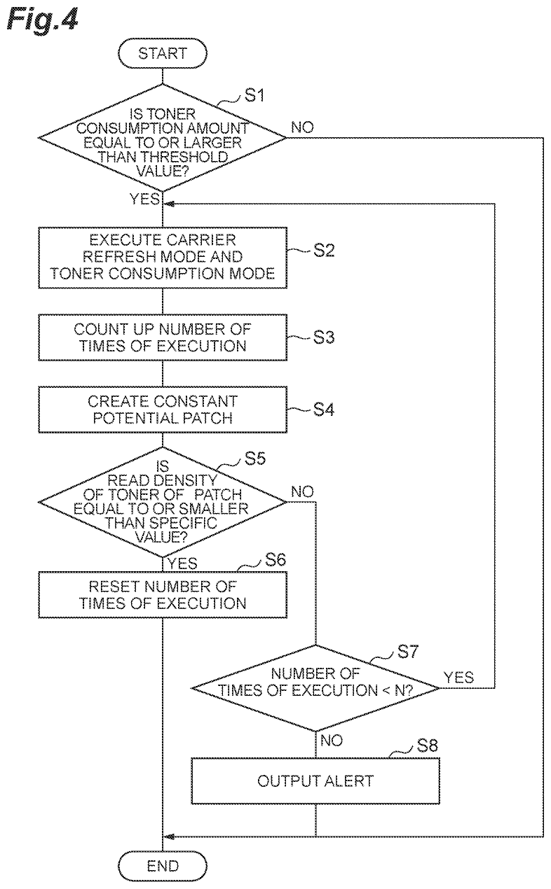

FIG. 4 shows a flowchart of an example method for implementing the carrier refresh mode and the toner consumption mode. As described above, the carrier refresh mode and the toner consumption mode may be executed when there is no print job. For example, the mode may be executed either after the print job is finished or at night. The example method includes determining, by the control unit 80, whether or not the toner consumption amount of the image forming apparatus 1 is equal to or larger than a threshold value (S1). A large amount of toner consumption indicates that the external additive adheres to the carrier and that the carrier is contaminated. For example, the control unit 80 may count the number of print dots and may determine that the toner consumption amount is equal to or larger than a threshold value when the counted number of print dots is equal to or larger than a predetermined value. Further, the control unit 80 integrates the operation time of the toner cartridge 60 and may determine that the toner consumption amount is equal to or larger than the threshold value when the integrated operation time of the toner cartridge 60 is equal to or larger than a predetermined time.

In S1, when the control unit 80 determines that the toner consumption amount is not equal to or larger than the threshold value, the example method ends. In ste S1, when the toner consumption amount is equal to or larger than the threshold value, the control unit 80 executes the carrier refresh mode and the toner consumption mode (S2). At this time, the supply of the toner from the toner cartridge 60 to the developing device 20 is stopped, and the developing device 20 develops and sends the toner in the developer to the photoreceptor 10 and the cleaner 50.

The rotation speed of the conveying member 53 of the cleaner 50 is set to be slower than the rotation speed during printing. Accordingly, since the toner returns from the cleaner 50 to the developing device 20, the toner-carrier mixing ratio of the developing device 20 decreases. For example, the toner-carrier mixing ratio during printing in the developing device 20 may be equal to or larger than 5% and equal to or smaller than 7%, and the toner-carrier mixing ratio in the carrier refresh mode of the developing device 20 may be equal to or larger than 1.5% and equal to or smaller than 3.5%.

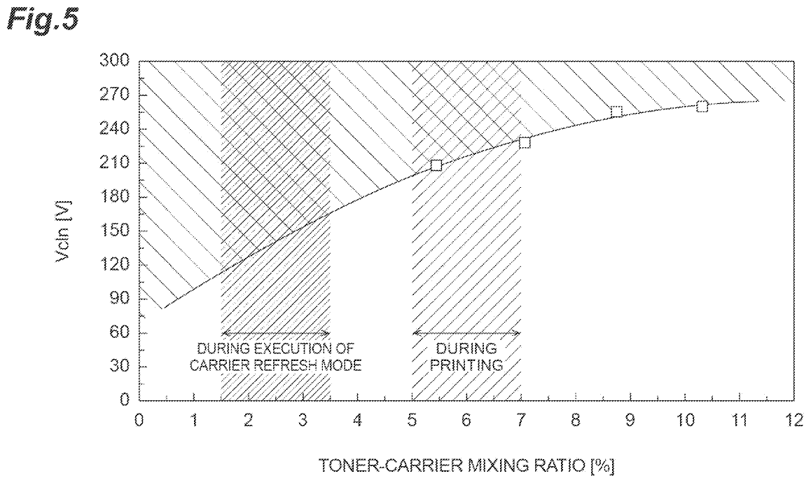

In the development of the carrier refresh mode, for example, a toner image may be thinner than the toner image during printing. Then, a bias is set to a value smaller than the bias during printing. More specifically, a value of a cleaning field (Vcln), which is a potential difference between a charge voltage of the charging device 40 and a developing voltage (developing bias) to the developing device 20, decreases. As shown in FIG. 5, an example graph showing a relationship between a voltage value and a ratio of a toner with respect to a carrier, there is a correlation between the value of Vcln and the toner-carrier mixing ratio. When the value of Vcln exceeds a predetermined voltage while the toner-carrier mixing ratio is constant, the carrier scatters from the developing device 20 to the photoreceptor 10. In other words, the carrier scattering occurs in the region above the curve of the graph shown in FIG. 5. The control unit 80 decreases the value of Vcln from in order to suppress the carrier scattering. For example, the value of Vcln may be decreased to 120 V or less. Accordingly, the carrier may be suppressed from being transferred from the developing device 20 to the photoreceptor 10.

When the developing roller 21 rotates while the toner-carrier mixing ratio of the developing device 20 is decreased to be smaller than the ratio during printing, the external additive is scraped off from the carrier. This external additive separates from the developing roller 21 and enters the external additive containing portion 27. At this time, the external additive may be sucked to the external additive containing portion 27 by operating the suction device 27c. As described above, the carrier is refreshed by removing the external additive from the carrier in the developing device 20.

The control unit 80 counts up the number of times of executing the carrier refresh mode (S3). After the carrier refresh mode ends, the value of Vcln is set to be the same as the value during printing, the rotation speed of the conveying member 53 is set to be the same as the rotation speed during printing, and the toner of the cleaner 50 is returned to the developing device 20. Accordingly, the toner-carrier mixing ratio of the developing device 20 is returned to the state before the execution of the carrier refresh mode, and the TC sensor 26 confirms that the toner-carrier mixing ratio has returned.

The control unit 80 creates a constant potential patch (S4). At this time, a patch imaged with a constant potential setting is created. Then, the optical sensor 45 detects the density of the toner image in the path. The density of the toner image has a correlation with the charge amount Q/M of the developer. The charge amount Q/M indicates a ratio of a mass (M) with respect to a charge amount (Q) of the developer. There is a substantially linear relationship between the charge amount of the developer and the density of the toner image. The charge amount of the developer increases as the density of the toner image decreases, and the charge amount of the developer decreases as the density of the toner image increases. Deterioration of the developer (e.g., decrease in the charge amount) may be detected by calculating the charge amount of the developer when the optical sensor 45 detects the density of the toner image. In S5, the control unit 80 determines whether or not the charge amount of the developer is equal to or larger than a predetermined value by determining whether or not the read density of the toner image is equal to or smaller than a specific value.

In S5, when the control unit 80 determines that the density of the toner image of the patch created at a constant potential is equal to or smaller than the specific value, the number of times of executing the carrier refresh mode is reset (S6), and the example method ends. In S5, when the control unit 80 determines that the density of the toner image of the patch created at a constant potential is not equal to or smaller than the specific value, the method continues to S7 to determine whether or not the number of times of executing the carrier refresh mode is smaller than N times (N is a natural number of 2 or greater) (S7). For example, N may be 2.

In S7, when the control unit 80 determines that the number of times of executing the carrier refresh mode is smaller than N times, the carrier refresh mode is executed again (S2). In S7, when the control unit 80 determines that the number of times of executing the carrier refresh mode is not smaller than N times, for example, an alert prompting replacement of the developing device 20 is output (S8). Then, the example method ends.

The image forming apparatus 1 is described herein in accordance with example operations and effects. The control unit 80 controls the execution of the carrier refresh mode by driving the auger 22 when the remaining amount of the toner in the developing device 20 becomes smaller than a threshold value. The carrier refresh mode is executed while the toner-carrier mixing ratio in the developing device 20 is reduced by the toner consumption mode. The external additive may be removed by scraping off the external additive from the carrier of the developing device 20 in accordance with the driving of the auger 22 and the rotation of the developing roller 21. As a result, since the carrier can be refreshed, the life of the developer and the developing device 20 may be extended.

The developing device 20 includes the external additive containing portion 27 to store the external additive scraped off from the carrier. Thus, the external additive scraped off from the carrier can be accumulated in the external additive containing portion 27. The suction device 27c connected to the developing device 20 sucks the external additive to the external additive containing portion 27. Thus, the external additive scattering from the developing roller 21 can be sucked and accumulated in the external additive containing portion 27. The control unit 80 outputs an alert when the number of times of executing the carrier refresh mode is equal to or larger than a predetermined number of times (for example, N times). By this alert, the replacement of the developing device 20 can be prompted.

The control unit 80 executes the carrier refresh mode and the toner consumption mode when there is no print job. Thus, the carrier can be refreshed when there is no print job. As described above, the control unit 80 may include the dot counter, and the control unit 80 may execute the carrier refresh mode and the toner consumption mode when the number of dots counted by the dot counter exceeds a threshold value. In this case, the carrier may be refreshed when the toner consumption amount becomes equal to or larger than a threshold value. Further, the control unit 80 may execute the carrier refresh mode when the operation time of the toner cartridge 60 exceeds a threshold value. In this way, the toner consumption amount may be determined based on the operation time of the toner cartridge 60.

The image forming apparatus 1 includes the cleaner 50 to remove a toner remaining on the surface 11 of the photoreceptor 10, and the cleaner 50 includes the toner return path 70 via which the conveyed toner returns to the developing device 20. The control unit 80 may stop the toner from being transferred from the toner return path 70 to the developing device 20 in the carrier refresh mode. In this case, the toner-carrier mixing ratio of the developing device 20 may be decreased. The control unit 80 controls the rotation of the conveying member 53 so that the rotation speed of the conveying member 53 in the toner consumption mode becomes slower than the rotation speed of the conveying member 53 during printing. Since the toner can be accumulated in the cleaner 50 by slowing the rotation speed of the conveying member 53 of the cleaner 50, the toner-carrier mixing ratio of the developing device 20 may be decreased by delaying the return of the toner to the developing device 20.

Further, the cleaner 50 includes two conveying members 53 and the partition wall 54. One of the two conveying members 53 (e.g., a first conveying member) conveys a toner to the end portion in the conveying direction D1. Then, the other of the two conveying members 53 (e.g., a second conveying member) conveys the toner in a direction D2 (e.g., opposite to the conveying direction D1) and conveys the toner to the end portion in the direction D2. Thus, since the toner inside the cleaner 50 can be accumulated for a long time, the toner-carrier mixing ratio of the developing device 20 may be decreased more reliably.

It should be understood that aspects, advantages, and features described herein are not necessarily achieved or included in any one particular example. Indeed, while various examples have been described and shown herein, it should be apparent that other examples may be possible in terms of, for example, arrangement, substitution, combination, and/or configuration. All corrections and modifications included in the scope of the subject matter disclosed herein are claimed.

For example, in the description above, an example is described in which the control unit 80 integrates the operation time of the toner cartridge 60, and the control unit 80 determines that the toner consumption amount is equal to or larger than the threshold value when the integrated operation time of the toner cartridge 60 is equal to or larger than a predetermined time. However, the control unit 80 may determine that the toner consumption amount is equal to or larger than the threshold value when, for example, the weight of the toner cartridge 60 is equal to or smaller than a predetermined value. Further, the control unit 80 may determine that the toner consumption amount is equal to or larger than the threshold value when the torque of the toner cartridge 60 is equal to or larger than a predetermined value. In this way, a method of determining the toner consumption amount can be changed as appropriate. As described above, all corrections and modifications coming within the spirit and scope of the protected subject matter disclosed herein are claimed.

1. An image forming apparatus comprising:
a photoreceptor comprising a surface on which a toner image is formed;
a developing device comprising an auger to supply a developer, the developer containing a toner and a carrier; and
a control unit to control execution of a carrier refresh mode by driving the auger, when a remaining amount of the toner in the developing device becomes smaller than a threshold value.

2. The image forming apparatus according to claim 1, wherein the control unit executes the carrier refresh mode and a toner consumption mode to decrease a mixing ratio of the toner with respect to the carrier in the developing device by transferring the toner in the developing device to the photoreceptor.

3. The image forming apparatus according to claim 1,
wherein the developing device comprises a developing roller, and the auger supplies the developer to the developing roller; and
wherein, in the carrier refresh mode, a rotation of the developing roller is to scrape a surface of the carrier.

4. The image forming apparatus according to claim 1, wherein the developing device comprises an external additive containing portion to store an external additive, the external additive scraped off from the carrier in the carrier refresh mode.

5. The image forming apparatus according to claim 4, comprising a suction device connected to the developing device, the suction device to suck the external additive to the external additive containing portion.

6. The image forming apparatus according to claim 2, wherein the control unit executes the carrier refresh mode and the toner consumption mode when there is no print job to form an image on a print medium.

7. The image forming apparatus according to claim 2, comprising:
a dot counter to count the number of dots, the dots to form an image on a print medium, wherein the control unit executes the carrier refresh mode when the number of dots or a density of the toner in the developing device exceeds a threshold value.

8. The image forming apparatus according to claim 2, comprising:
a toner cartridge to supply the toner to the developing device,
wherein the control unit executes the carrier refresh mode when an operation time of the toner cartridge exceeds a threshold value.

9. The image forming apparatus according to claim 1,
wherein the control unit generates an alert when the number of times of executing the carrier refresh mode is equal to or larger than a predetermined number of times.

10. An image forming apparatus comprising:
a photoreceptor comprising a surface on which a toner image is formed;
a developing device comprising an auger to supply a developer, the developer containing a toner and a carrier; and
a control unit to control execution of a toner consumption mode by transferring the toner to the photoreceptor based on a remaining amount of the toner in the developing device, the control unit to control execution of a carrier refresh mode by driving the auger.

11. An image forming apparatus comprising:
a photoreceptor comprising a surface on which a toner image is formed;
a developing device comprising an auger to supply a developer, the developer containing a toner and a carrier;
a toner return path via which the toner is transferred from the photoreceptor to the auger; and
a control unit to control execution of a toner consumption mode by transferring the toner to the photoreceptor and the toner return path based on a remaining amount of the toner in the developing device, the control unit to control execution of a carrier refresh mode by driving the auger.

12. The image forming apparatus according to claim 11, comprising:
a cleaner to remove a remaining toner on the surface of the photoreceptor, wherein the cleaner comprises the toner return path.

13. The image forming apparatus according to claim 12, the cleaner comprising:
a toner conveying path; and
a conveying member that rotates inside the toner conveying path to convey the toner to the toner return path,
wherein the control unit controls the rotation of the conveying member such that a rotation speed of the conveying member in the toner consumption mode is slower than the rotation speed of the conveying member not in the toner consumption mode.

14. The image forming apparatus according to claim 13, the cleaner comprising:
two conveying members extending along an axis of the toner conveying path; and
a partition wall located between a first conveying member of the two conveying members and a second conveying member of the two conveying members;
wherein the first conveying member is to convey the toner to a first end portion in a first conveying direction, and the second conveying member is to convey the toner to a second end portion in a second conveying direction.

15. The image forming apparatus according to claim 11, wherein the control unit is to stop the toner from being transferred from the toner return path to the developing device in the carrier refresh mode.
